(19) United States
(12) Patent Application Publication
(10) Pub. No.: US 2012/0296941 A1
(43) Pub. Date: Nov. 22, 2012

(54) Method and Apparatus for Modelling Personalized Contexts

(75) Inventors: Happia Cao, Beijing (CN); Tengfei Bao, Hefei (CN); Jilei Tian, Beijing (CN)

(73) Assignee: NOKIA CORPORATION, Espoo (FI)

(21) Appl. No.: 13/576,615

(22) PCT Filed: Feb. 3, 2010
(86) PCT No.: PCT/CN2010/070498

§ 371 Date: Aug. 1, 2012

(51) Int. Cl. G06F 17/30

(52) U.S. Cl. 707/802; 707/E17.127

(57) ABSTRACT

Various methods for modeling personalized contexts are provided. One example method includes accessing a context data set comprised of a plurality of context records. The context records may include a number of contextual feature-value pairs. The example method may also include generating at least one grouping of contextual feature-value pairs based on a co-occurrence of the contextual feature-value pairs in context records, and defining at least one user context based on the at least one grouping of contextual feature-value pairs. Similar and related example methods and example apparatuses are also provided.

### TECHNICAL FIELD

Embodiments of the present invention relate generally to context information analysis, and, more particularly, relate to a method and apparatus for modeling personalized contexts.

### BACKGROUND

Recent advances in processing power and data storage have substantially expanded the capabilities of mobile devices (e.g., cell phones, smart phones, media players, and the like). These devices may now support web browsing, email, text messaging, gaming, and a number of other types of applications. Further, many mobile devices can now determine the current location of the device through positioning techniques such as through global positioning systems (GPSs). Additionally, many devices have sensors for capturing and storing context data, such as position, speed, ambient noise, time, and other types of context data.

Due to the number of applications and the overall usefulness of mobile devices, many users have become reliant upon the devices for many daily activities and keeping the devices in their immediate possession. Additionally, some users have come to rely on a cell phone as their only means for telephone communications. Some users store all their contact information and appointments in their mobile device. Others use their mobile device for web browsing and media playback. As a result of the regular interactions between the mobile device and the user, the mobile device has the ability to gain access to a plethora of information about the user, and the user's activities.

### BRIEF SUMMARY

Example methods and example apparatuses are described herein that model personalized contexts of individuals based on information captured by mobile devices. According to some example embodiments, the contexts may be defined in an unsupervised manner, such that the contexts are defined based on the content of a context data set, rather than being predefined. To define a context, historical context data, possibly captured by a mobile terminal, may be arranged into a context data set of records. A record may include a number of contextual feature-value pairs. A context may be defined by grouping contextual feature-value pairs based on their co-occurrences in context records. In some example embodiments, grouping contextual feature-value pairs based on their co-occurrences in context records may involve grouping contextual feature-value pairs by applying a topic model to the records or performing clustering of the records. In example embodiments where a topic model is applied, a feature template variable may be utilized that describes the contextual features included in a given context record. In some example embodiments, the topic model may be a Latent Dirichlet Allocation model extended to include the contextual feature template variable.

Various example methods and apparatuses of the present invention are described herein, including example methods for modeling personalized contexts. One example method includes accessing a context data set comprised of a plurality of context records. The context records may include a number of contextual feature-value pairs. The example method may also include generating at least one grouping of contextual feature-value pairs based on a co-occurrence of the contextual feature-value pairs in context records, and defining at least one user context based on the at least one grouping of contextual feature-value pairs.

An additional example embodiment is an apparatus configured for modeling personalized contexts. The example apparatus comprises at least one processor and at least one memory including computer program code, the at least one memory and the computer program code being configured to, with the at least one processor, direct the apparatus to perform various functionalities. The example apparatus may be caused to perform accessing a context data set comprised of a plurality of context records. The context records may include a number of contextual feature-value pairs. The example apparatus may also be caused to perform generating at least one grouping of contextual feature-value pairs based on a co-occurrence of the contextual feature-value pairs in context records, and defining at least one user context based on the at least one grouping of contextual feature-value pairs.

Another example embodiment is a computer program product comprising a computer-readable storage medium having computer program code stored thereon, wherein execution of the computer program code causes an apparatus to perform various functionalities. Execution of the computer program code may cause an apparatus to perform accessing a context data set comprised of a plurality of context records. The context records may include a number of contextual feature-value pairs. Execution of the computer program code may also cause the apparatus to perform generating at least one grouping of contextual feature-value pairs based on a co-occurrence of the contextual feature-value pairs in context records, and defining at least one user context based on the at least one grouping of contextual feature-value pairs.

Another example embodiment is a computer readable medium having computer program code stored therein, wherein the computer program code is configured to cause an apparatus to perform various functionalities. The computer program code may cause an apparatus to perform accessing a context data set comprised of a plurality of context records. The context records may include a number of contextual feature-value pairs. The computer program code may also cause the apparatus to perform generating at least one grouping of contextual feature-value pairs based on a co-occurrence of the contextual feature-value pairs in context records, and defining at least one user context based on the at least one grouping of contextual feature-value pairs.

Another example apparatus includes means for accessing a context data set comprised of a plurality of context records. The context records may include a number of contextual feature-value pairs. The example apparatus may also include means for generating at least one grouping of contextual feature-value pairs based on a co-occurrence of the contextual feature-value pairs in context records, and means for defining at least one user context based on the at least one grouping of contextual feature-value pairs.

### BRIEF DESCRIPTION OF THE DRAWING(S)

Having thus described the invention in general terms, reference will now be made to the accompanying drawings, which are not necessarily drawn to scale, and wherein:

FIG. 1a illustrates an example bipartite between contextual feature-value pairs and unique context records according to an example embodiment of the present invention;

FIG. 1b illustrates an example algorithm for clustering contextual feature-value pairs by K-means according to an example embodiment of the present invention;

FIG. 2 illustrates a graphical representation of a Latent Dirichlet Allocation on Context model for use with modeling contexts according to an example embodiment of the present invention;

FIG. 3 illustrates a block diagram of an apparatus and associated system for modeling personalized contexts according to an example embodiment of the present invention;

FIG. 4 illustrates a block diagram of a mobile terminal configured to model personalized contexts according to an example embodiment of the present invention; and

FIG. 5 illustrates a flow chart of a method for modeling personalized contexts according to an example embodiment of the present invention.

### DETAILED DESCRIPTION

Example embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout. The terms “data,” “content,” “information,” and similar terms may be used interchangeably, according to some example embodiments of the present invention, to refer to data capable of being transmitted, received, operated on, and/or stored.

As used herein, the term ‘circuitry’ refers to all of the following: (a) hardware-only circuit implementations (such as implementations in only analog and/or digital circuitry); (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

According to some example embodiments, apparatuses and methods are provided herein that perform context modeling of a user's activities by leveraging the rich contextual information captured by a user's mobile device. Using rich context modeling to model the personalized context pattern, according to some example embodiments, may be complex, and even more so when the data used for the modeling is automatically mined from sparse, heterogeneous, and incomplete context data observed from and captured by a mobile device. These characteristics of the context data arise from the mobile devices frequently being in volatile contexts, such as waiting for a bus, working in the office, driving a car, or entertaining during free time. Despite the data issues, generated context models may be quite useful and can be leveraged in a number of context-aware services and applications, such as targeted marketing and advertising, and making personalized recommendations for goods and services.

Context modeling, according to some example embodiments described herein, can be performed via an unsupervised learning approach that is performed automatically to determine semantically meaningful contexts of a user from historical context data. According to some example embodiments, an unsupervised approach can be more flexible because it does not rely upon domain knowledge and/or predefined contexts. Each context record in a context data set may be in the form of a combination of several contextual feature-value pairs, such as {(Is a holiday?=Yes), (Speed=High), (Time range=AM8:00-9:00), (Audio level=High)}. The unsupervised approach may automatically learn a mobile device user's personalized contexts from the historical context data stored on his (or her) mobile device because the context is data driven.

To model the personalized contexts of a user, the user's historical context data may be captured as training data by, for example, the user's mobile device. The collected context data set may consist of a number of context records, where a context record includes several contextual feature-value pairs. According to some example embodiments, to obtain such a context data set, a mobile device may be configured, possibly via software, to capture and store data received by sensors or applications. Data collection may be continuous with a predefined sampling rate or under user control. The set of contextual features to be collected may be predefined. However, a context record may, according to some example embodiments, lack the values of some contextual features because the values of certain contextual features may not always be available. For example, when a user is indoors, a mobile device may not be able to receive a global positioning system (GPS) signal. In this case, the coordinates of the user's current position and the moving speed of the user may not be available. In response to this condition, the mobile device may attempt to collect alternative contextual features data. For example, when the GPS signal is not available, the mobile device may use a Cell ID from the cellular communications system, and replace the Cell ID with the exact location coordinates. The mobile device may also be configured to use a three dimensional accelerator sensor's information to determine, for example, whether the user is moving, to replace the moving speed of the user.

TABLE 1
An example of context data set.

| ID | Context record |
|---|---|
| t₁ | {(Is a holiday? = No), (Time range = AM8:00-9:00), |
| | (Speed = High), (Location = (39.8555, 116.4064)), |
| | (Audio level = Low)} |
| t₂ | {(Is a holiday? = No), (Time range = AM8:00-9:00), |
| | (Speed = High), (Location = (39.8555, 116.4067)), |
| | (Audio level = Middle)} |
| t₃ | {(Is a holiday? = No), (Time range = AM8:00-9:00), |
| | (Speed = High), (Location = (39.8557, 116.4072)), |
| | (Audio level = Middle)} |
| t₄ | {(Is a holiday? = No), (Time range = AM8:00-9:00), |
| | (Speed = High), (Location = (39.8557, 116.4072)), |
| | (Audio level = Middle)} |

. . .

| | |
|---|---|
| t₃₈ | {(Is a holiday? = No), (Time range = AM10:00-11:00), |
| | (Movement = Not moving), (Audio level = Low), |
| | (Inactive time = Long)} |
| t₃₉ | {(Is a holiday? = No), (Time range = AM10:00-11:00), |
| | (Movement = Not moving), (Audio level = Low), |
| | (Inactive time = Long)} |
| t₄₀ | {(Is a holiday? = No), (Time range = AM10:00-11:00), |
| | (Movement = Not moving), (Audio level = Low), |
| | (Inactive time = Long)} |

. . .

| | |
|---|---|
| t₅₈ | {(Is a holiday? = Yes), (Time range = AM10:00-11:00), |
| | (Movement = Moving), (Cell ID = 2552), |
| | (Audio level = Middle)} |
| t₅₉ | {(Is a holiday? = Yes), (Time range = AM10:00-11:00), |
| | (Movement = Moving), (Cell ID = 2552), |
| | (Audio level = High)} |
| t₆₀ | {(Is a holiday? = Yes), (Time range = AM10:00-11:00), |
| | (Movement = Moving), (Cell ID = 2552), |
| | (Audio level = Middle)} |

Table 1 shows an example of a context data set. Consider an example scenario where the context data set of Table 1 is the historical context data of an individual named Ada. According to various example embodiments, meaningful contexts may be derived for Ada from the context data set. Based on the data provided in Table 1, on work days from AM8:00-AM9:00, Ada's moving speed, as captured by her mobile device, was high and the background was noisy (reflected by the audio level), which might imply that the context is she was driving a car to her work place. Additionally, on a work days from AM10:00-AM11:00, Ada did not move and had not used her mobile device for a long time (reflected by the inactive time of the mobile device), which may imply the context is that she was busy working in her office. Finally, during a holiday from AM10:00-AM11:00, Ada was moving indoors and the background is noisy. Considering that the cell ID is associated with a shopping mall, the context might be that Ada was going shopping.

Context records, as described above, may reflect a specific latent context. If two contextual feature-value pairs usually co-occur in same context records, then the contextual feature-value pairs may be grouped and represent the same context, As such, according to various example embodiments a number of unsupervised approaches for learning contexts from context data sets may be utilized, including a clustering based approach and a topic model based approach.

In a clustering based approach, similar contextual feature-value pairs, in terms of the presence of co-occurrences, may be grouped or, in this case, clustered, and the resultant groups may correspond to a latent context. According to some example embodiments, an effective co-occurrence based similarity measurement may be utilized to calculate the similarity between feature-value pairs. Then, a K-means algorithm may be used to cluster the similar contextual feature-values as contexts.

To capture the co-occurring relationships between contextual feature-value pairs, a bipartite may be built between contextual feature-value pairs and the unique context records from the context data set. The bipartite may be referred to as a PR-bipartite (contextual feature-value Pair and unique context Record). According to some example embodiments, the PR-bipartite may be defined as:
a set of P-nodes P={pᵢ}, where each P-node corresponds to a contextual feature-value pair;
a set of R-nodes R={rⱼ}, where each R-node corresponds to a unique context record;
a set of edges E={e_{i,j}}, where e_{i,j} connects a P-node pᵢ and a R-node rⱼ and means that the pᵢ occurs in rⱼ; and
a set of weights W={w_{i,j}}, where w_{i,j} indicates the weight of e_{i,j}·w_{i,j} is equal to the frequency of rⱼ in the context data set.

In a PR-bipartite, if two P-nodes, pᵢ_{₁} and pᵢ_{₂}, are both connected to one R-node rⱼ by the edges eᵢ_{₁}_{,j} and eᵢ_{₂}_{,j}, respectively, it may be implied that pᵢ_{₁} and pᵢ_{₂} co-occur in rⱼ. Accordingly, wᵢ_{₁}_{,j} may be equal to wᵢ_{₂}_{,j}, according to the definition of weight of edges in a PR-bipartite. Further, both wᵢ_{₁}_{,j} and wᵢ_{₂}_{,j} may indicate the frequency that pᵢ_{₁} co-occurs with pᵢ_{₂} with respect to rⱼ.

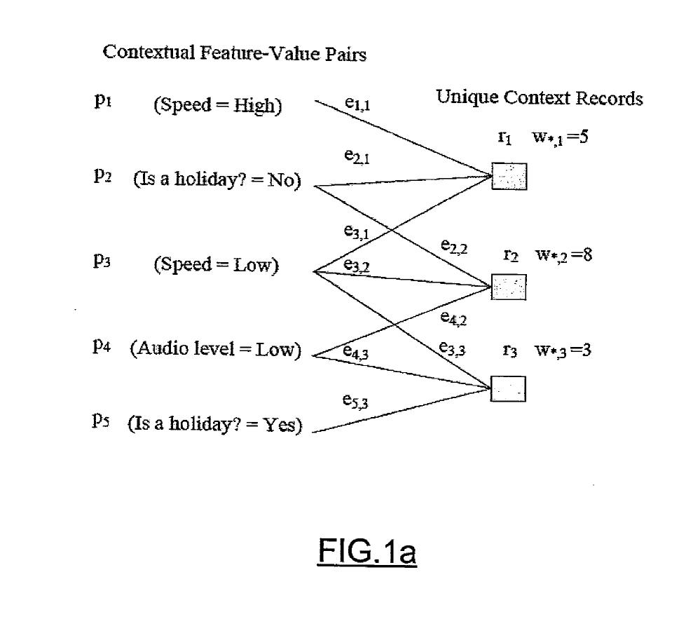

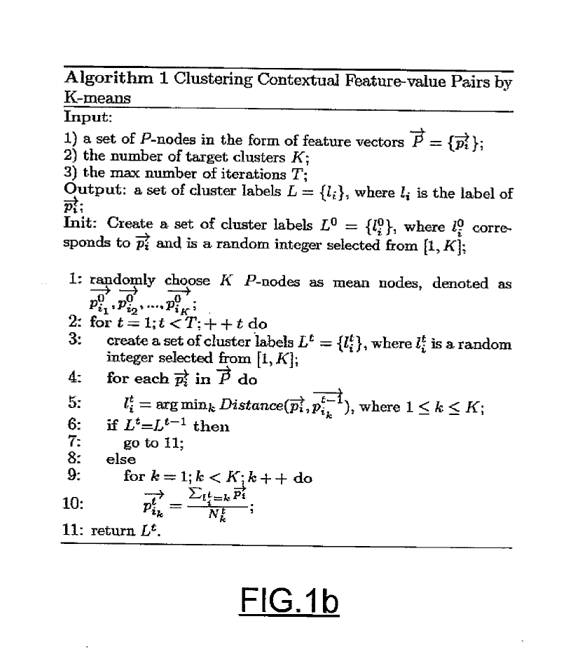

FIG. 1a provides an example of a PR-bipartite. The co-occurring relations between contextual feature-value pairs may be captured by a PR-bipartite, as indicated in FIG. 1. For example, the contextual feature-value pairs (Is a holiday?=No) and (Speed=Low) co-occur in context records r₁ and r₂, five times and eight times, respectively.

Given a PR-bipartite built from the context data set, a contextual feature-value pair pᵢ may be represented as an L₂-normalized feature vector, where each dimension corresponds to one unique context record. In this regard, for example, the j-th element of the feature vector of a contextual feature-value pair pᵢ may be:

$${p}_{i , j} = \{ \begin{matrix}Norm ( {ω}_{i , j} ) & if edge {e}_{i , j} ∈ E ; \\ 0 & otherwise ,\end{matrix} \\ where Norm ( {w}_{i , j} ) = \frac{{w}_{i , j}}{\sqrt{{\sum }_{∀ {e}_{i , k}} {w}_{i , k}^{2}}} . \qquad ( 1 )$$

The similarity between two contextual feature-value pairs pᵢ_{₁} and pᵢ_{₂} be measured by the Euclidean distance between the contextual feature-pairs' normalized feature vectors. According to some example embodiments, that is

$$Distance ( \vec{{p}_{{i}_{1}}} , \vec{{p}_{{i}_{2}}} ) = \sqrt{{\sum }_{j = 1}^{R} {( {p}_{{i}_{1} , j} - {p}_{{i}_{2} , j} )}^{2}} , \qquad ( 2 )$$

A similarity measurement of this type may indicate that two contextual feature-value pairs are similar, if the pairs co-occur frequently in the context data set.

With the similarity measurement of the contextual feature-value pairs, the contextual feature-value pairs may be clustered and a context may be defined with respect to a cluster. Since the similarity measurement is in a form of distance function of two vectors, a spatial clustering algorithm may be utilized. Spatial clustering algorithms can be divided into three categories, namely, partition based clustering algorithms (e.g., K-means), density based clustering algorithms (e.g., Density-Based Spatial Clustering of Applications with Noise (DBSCAN)), and stream based clustering algorithms (e.g., Balanced Iterative Reducing and Clustering using Hierarchies (BIRCH)). Both the density based clustering algorithms and the stream based clustering algorithms may require a predefined parameter to control the granularity of the clusters. Because the properties of different contexts may be volatile, the granularity of different clusters may be diverse when using clusters for representing contexts. For example, a context that the user is working in the office may last for several hours and may contain many different contextual feature-value pairs, while another context that the user is waiting for a bus may last for several minutes and may contain less contextual feature-value pairs. Therefore, according to some example embodiments, controlling the granularity of all clusters may not be possible using a single predefined parameter.

However, for partition based clustering of contextual feature-value pairs, the K-means clustering algorithm may be used. In this regard, K P-nodes may first be randomly selected as the mean nodes of K clusters, and other P-nodes may be assigned to the K clusters according to the nodes' distances to the mean nodes. The mean of each cluster may then be iteratively calculated and the P-nodes may be reassigned until the assignment does not change or the iteration exceeds the maximum number of iterations. Algorithm 1 as depicted in FIG. 1b shows example pseudo code of clustering contextual feature-value pairs by K-means, where, according to some example embodiments, L¹=L^{t-1} means ∀₁(l₁^{t}=(l₁^{t-1}) and Nₖ^{t} indicates the number of P-nodes with label k in the t-th iteration.

Partition based clustering algorithms may need a predefined parameter K that indicates a number of target clusters. Thus, to select an appropriate value for K, an assumption may be made that the number of contexts for mobile device users may fall into a range [Kₘᵢₙ, Kₘₐₓ], where Kₘᵢₙ and Kₘₐₓ indicate the minimum number and the maximum number of the possible contexts, respectively. The values of Kₘᵢₙ and Kₘₐₓ may be approximated or, for example, be empirically determined by a study that selects users with different backgrounds and inquires as to how many typical contexts exist in the users' daily life. As a result, a value for K may be selected from [Kₘᵢₙ, Kₘₐₓ] by measuring, for example, the clustering quality for a specific user's context data set.

The clustering quality may be indirectly determined by evaluating the quality of learnt contexts from modeling the context data set. In this regard, according to some example embodiments, the context data set D may first be partitioned into two parts, namely, a training set Dₐ and a test set D_{b}. K-means may be performed on Dₐ with a given K, and K clusters of P-nodes may be obtained as K contexts c₁, c₂, . . . , c_{K}. The perplexity of D_{b} may be calculated by:

$$Perplexity ( {D}_{b} ) = Exp [ - \frac{{\sum }_{r ∈ {D}_{b}} {freq}_{r} \cdot log P ( r \vert {D}_{a} )}{{\sum }_{r ∈ {D}_{b}} {freq}_{r} \cdot {N}_{r}} ] \qquad ( 3 )$$

where r denotes a unique context record of D_{b}, freqᵣ indicates the frequency r in D_{b}, P(r|Dₐ) means the probability that r occurs given Dₐ, and Nᵣ indicates the number of contextual feature-value pairs in r.

According to various example embodiments, in the clustering based context model, P(rₙ|Dₐ) may be calculated

$$\begin{matrix}P ( r \vert {D}_{a} ) = {\prod }_{{p}_{i} ∈ r} P ( {p}_{i} \vert {D}_{a} ) \\ = {\prod }_{{p}_{i} ∈ r} {\sum }_{{c}_{k}} P ( {p}_{i} , {c}_{k} \vert {D}_{a} ) \\ = {\prod }_{{p}_{i} ∈ r} P ( {p}_{i} , c \vert {D}_{a} ) \\ = {\prod }_{{p}_{i} ∈ r} P ( {p}_{i} \vert c ) P ( c \vert {D}_{a} )\end{matrix}$$

where pᵢ denotes a contextual feature-value pair of r, cₖ denotes a cluster of P-nodes, and c denotes the cluster to which pᵢ belongs. P(pᵢ|cₖ) may be calculated as

$$\frac{1}{\vert c \vert} ,$$

where |c| indicates the size of c. P(c|Dₐ) may be calculated as

$$\frac{{\sum }_{{p}_{j}} {∈}_{c} {freq}_{{p}_{j}}}{{\sum }_{{p}_{j}} {freq}_{{p}_{j}}} ,$$

where pᵢ denotes a P-node and freqₚ_{ᵢ} indicates the frequency of pᵢ's corresponding contextual feature-value pairs in Dₐ. In this regard, according to some example embodiments, the smaller the perplexity is, the better the learnt contexts' quality will be.

Further, the perplexity of K-means may roughly drop with an increase of K. According to some example embodiments, taking into account the perplexity, a maximum K may be selected within a given range, which may cause learnt model over-fitting. As a result, according to some example embodiments, if the reducing ratio of perplexity is less than τ, a larger K is not selected. According to some example embodiments, τ may be set to 10%.

According to some example embodiments, in the clustering based approach for context modeling, a contextual feature-value pair may belong to only one context. However, some contextual feature-value pairs may reflect different contexts when co-occurring with different other contextual feature-value pairs. For example, consider the content of Table 1. The contextual feature-value pair (Time range=AM10:00-11:00) may reflect the context that Ada is busy working in her office with the contextual feature-value pair (Is a holiday?=No), or the contextual feature-value pair may reflect the context that Ada is shopping with the contextual feature-value pair (Is a holiday?=Yes). As such, according to some example embodiments, probabilistic models may be utilized for multiple contextual feature-pair based contexts.

The Latent Dirichlet Allocation (LDA) model is one example of a generative probabilistic model. In some instances, the LDA model may be used for document modeling. In this regard, the LDA model may consider a document d as a bag of words {w_{d,i}} Given K topics and V words, to generate the word w_{d,i}, the model may first generate a topic z_{d,i} from a prior topic distribution for d. The model may then be used to generate w_{d,j} given the prior word distribution for z_{d,i}. In a corpus, both the prior topic distributions for different documents and the prior word distributions for different topics may follow the Dirichlet distribution.

In the LDA model, the topics may be represented by their corresponding prior word distributions. To utilize the LDA model for context data, the contextual feature-value pairs may correspond to words, and the context records may correspond to documents. Based on these correlations, the LDA model may be used for learning contexts in the form of distributions of contextual feature-value pairs. However, according to some example embodiments, since the contextual features of several contextual feature-value pairs in a context record must be mutually exclusive, the LDA model may be extended and be referred to as the Latent Dirichlet Allocation on Context (LDAC) model for fitting context records.

To satisfy the constraint on the context records, according to some example embodiments, the LDAC model introduces a random variable referred to as a contextual feature template in the generating process of context records. A contextual feature template may be a bag of contextual features which are mutually exclusive. Contextual feature templates may be determined based on the content of the context records. In this regard, for example, given a context record {(Is a holiday?=Yes),(Time range=AM10:00-11:00),(Movement=Moving),(Cell ID=2552),(Audio level=Middle)}, the corresponding contextual feature template may be {(Is a holiday?),(Time range),(Movement),(Cell ID),(Audio level)}.

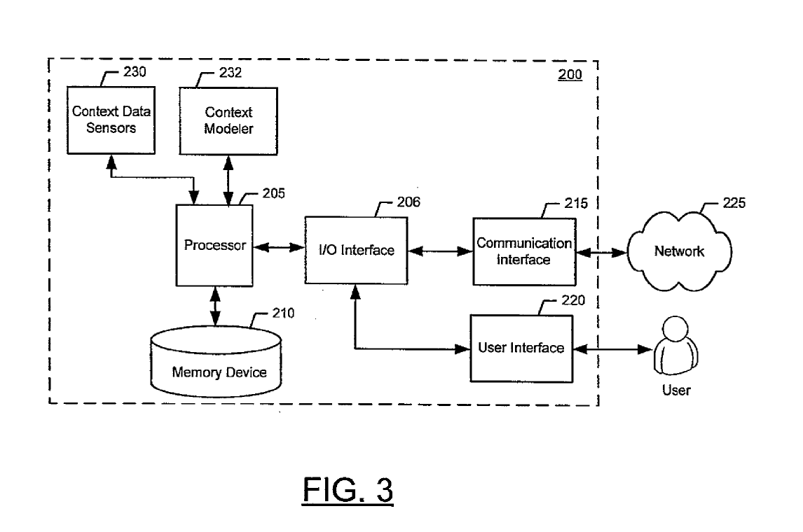

The LDAC model may assume that a context record is generated by a combination of a contextual feature template and a prior context distribution. In this regard, according to some example embodiments, given K contexts and F contextual features, the LDAC model may assume that a context record r is generated as follows. First, a prior context distribution θᵣ is generated from a prior Dirichlet distribution α. Second, a contextual feature template fᵣ may be generated from the prior distribution η. Then, for the i-th feature f_{r,i} in fᵣ, a context c_{r,i}=k may be generated from θᵣ and a contextual feature-value pair p_{r,i} may be generated from the distribution φ_{k,f}_{_{r,i}}. Further, a total of K×F prior distributions of contextual feature-value pairs {φ_{k,f}} may exist, which may follow a Dirichlet distribution β. FIG. 3 shows a graphical representation of the LDAC model, according to some example embodiments. It is noteworthy that α and β, according to some example embodiments, may be represented by parameter vectors \vec{α}={αₖ} and \vec{β}={βₚ}, respectively according to the definition of a Dirichlet distribution.

In the LDAC model, given the parameters α, β, and η, the joint probability of a context record r={p_{r,i}}, a prior context distribution θᵣ, a set of contexts cᵣ={c_{r,j}}, a contextual feature template fᵣ, and a set of K×F prior contextual feature-value pair distributions Φ={φ_{k,f}} may be calculated as:

$$P ( r , {θ}_{r} , {c}_{r} , {f}_{r} , Φ \vert α , β , η ) = ( {\prod }_{i = 1}^{{N}_{r}} P ( {p}_{r , i} \vert {c}_{r , i} , {f}_{r} , Φ ) P ( {c}_{r , i} \vert {θ}_{r} ) ) \times P ( {θ}_{r} \vert α ) P ( Φ \vert β ) P ( {f}_{r} \vert η ) ,$$

where P(p_{r,i}|c_{r,i},fᵣ,Φ)=P(p_{r,i}|c_{r,i},φc_{r,i},f_{r,i}) and Nᵣ indicates the number of contextual feature-value pairs in r.

The likelihood of the context data set D={r} may be calculated as:

$$\begin{matrix}L ( D ) = {\prod }_{r} P ( r \vert α , β , η ) \\ = {\prod }_{r} \int \int ( {\prod }_{i = 1}^{{N}_{r}} {\sum }_{{c}_{r , i}} P ( {p}_{r , i} \vert {c}_{r , i} , {f}_{r} , Φ ) P ( {c}_{r , i} \vert {θ}_{r} ) ) \times \\ P ( {θ}_{r} \vert α ) P ( Φ \vert β ) P ( {f}_{r} \vert η ) d {θ}_{r} d Φ ,\end{matrix}$$

Similar to the original LDA model, rather than calculate the parameters directly, an iterative approach for approximately estimating the parameters of LDA, such as the Gibbs sampling approach, may be utilized. In the Gibbs sampling approach, observed data may be iteratively assigned a label by taking into account the labels of other observed data. The Dirichlet parameter vectors \vec{α} and \vec{β} may be empirically predefined and the Gibbs sampling approach may be used to iteratively assign context labels to each contextual feature-value pair according to the labels of other contextual feature-value pairs. Denoting m as the token (r, i), cₘ may be used to indicate the context label of pₘ, that is, in the i-th contextual feature-value pair in the record r, and the Gibbs sampler of cₘ may be:

$$P ( {c}_{m} = {k}_{m} \vert {C}_{m} , D , {F}_{D} ) = \frac{P ( {C}_{D} , D , {F}_{D} )}{P ( {C}_{m} , {R}_{m} , {F}_{m} ) P ( {p}_{m} , {f}_{m} )} = \frac{Δ ( \vec{{n}_{r}} + \vec{α} ) \cdot Δ ( \vec{{n}_{{k}_{m} , {f}_{m}}} + \vec{β} )}{Δ ( \vec{{n}_{r , m}} + \vec{α} ) \cdot Δ ( \vec{{n}_{{k}_{m} , {f}_{m} , m}} + \vec{β} ) \cdot P ( {p}_{m} , {f}_{m} )} ∝ \frac{Γ ( {n}_{r , {k}_{m}} + {α}_{{k}_{m}} ) Γ ( {\sum }_{k = 1}^{K} {n}_{r , m , k} + {α}_{k} )}{Γ ( {n}_{r , m , {k}_{m}} + {α}_{{k}_{m}} ) Γ ( {\sum }_{k = 1}^{K} {n}_{r , k} + {α}_{k} )} \times \frac{Γ ( {n}_{{k}_{m} , {f}_{m} , {p}_{m}} + {β}_{{p}_{m}} ) Γ ( {\sum }_{p} {n}_{{k}_{m} , {f}_{m} , m , p} + {β}_{p} )}{Γ ( {n}_{{k}_{m} , {f}_{m} , m , {p}_{m}} + {β}_{{p}_{m}} ) Γ ( {\sum }_{p} {n}_{{k}_{m} , {f}_{m} , p} + {β}_{p} )} ∝ \frac{{n}_{{k}_{m} , {f}_{m} , m , {p}_{m}} + {β}_{{p}_{m}}}{{\sum }_{p} {n}_{{k}_{m} , {f}_{m} , m , p} + {β}_{p}} \times ( {n}_{r , m , {k}_{m}} + {α}_{{k}_{m}} ) ,$$

where [symbol] m means removing pₘ from D, fₘ indicates the contextual feature of pₘ, n_{r,k} indicates the number of contextual feature-value pairs with context label k in r, nₖ_{ₘ}_{,f}_{_{m,p}} indicates the number of times that the contextual feature-value pair p's contextual feature is fₘ, and the context label is kₘ, \vec{n}ᵣ={n_{r,k}}, {right arrow over (nₖ_{_{m,fm}})}={nₖ_{ₘ}_{,f}_{ₘ}_{,p}} and

$$Δ ( \vec{α} ) = \frac{{\prod }_{k = 1}^{Dim ( \vec{α} )} Γ ( {α}_{k} )}{Γ ( {\sum }_{k = 1}^{Dim ( \vec{α} )} {α}_{k} )} .$$

After completing several rounds of Gibbs sampling, each contextual feature-value pair of the context data set may eventually be assigned a final context label. Contexts may be derived from the labeled contextual feature-value pairs by estimating the distributions of contextual feature-value pairs given a context. In this regard, according to various example embodiments, the probability that a contextual feature-value pair pₘ may be generated given the context cₖ, may be estimated as P(pₘ|cₖ)=P(pₘ|cₖ,fₘ)P(fₘ|cₖ), where

$$P ( {p}_{m} \vert {c}_{k} , {f}_{m} ) = \frac{{n}_{k , {f}_{m} , {p}_{m}} + {β}_{{p}_{m}}}{{\sum }_{p} {n}_{k , {f}_{m} , p} + {β}_{p}}$$

$$P ( {f}_{m} \vert {c}_{k} ) = \frac{{\sum }_{p} {n}_{k , {f}_{m} , p}}{{\sum }_{f} {\sum }_{p} {n}_{k , f , p}} .$$

Similar to the clustering based approach for context modeling, the LDAC model may also utilize a parameter K to indicate the number of contexts. The range of K may be determined through a user study to select K with respect to the perplexity. Additionally, the predefined parameter r may be utilized for reducing the risk of over-fitting. In the LDAC model, P(r|Dₐ) may be calculated as:

$$\begin{matrix}P ( r \vert {D}_{a} ) = {\prod }_{{p}_{m} ∈ r} P ( {p}_{m} \vert {D}_{a} ) \\ = {\prod }_{{p}_{m} ∈ r} {\sum }_{k = 1}^{K} P ( {p}_{m} \vert {c}_{k} , {D}_{a} ) P ( {c}_{k} \vert {D}_{a} ) ,\end{matrix}$$

$$where$$

$$P ( {p}_{m} \vert {c}_{k} , {D}_{a} ) = P ( {p}_{m} \vert {c}_{k} ) and$$

$$p ( {c}_{m} = k \vert {D}_{a} ) = P ( {c}_{m} = k \vert {θ}_{r} ) = \frac{{n}_{r , k} + {α}_{k}}{{\sum }_{{k}^{′} = 1}^{K} {n}_{r , {k}^{′}} + {α}_{{k}^{′}}} .$$

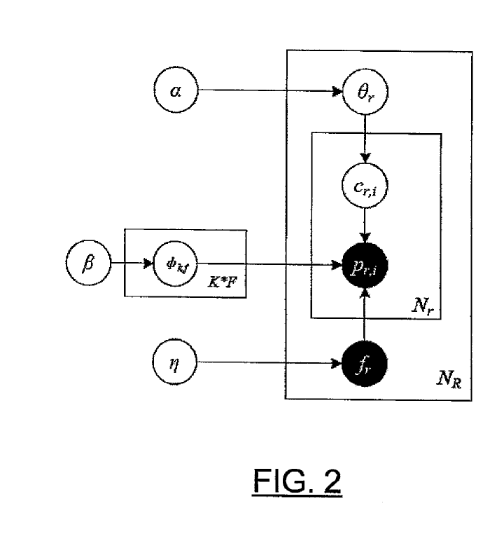

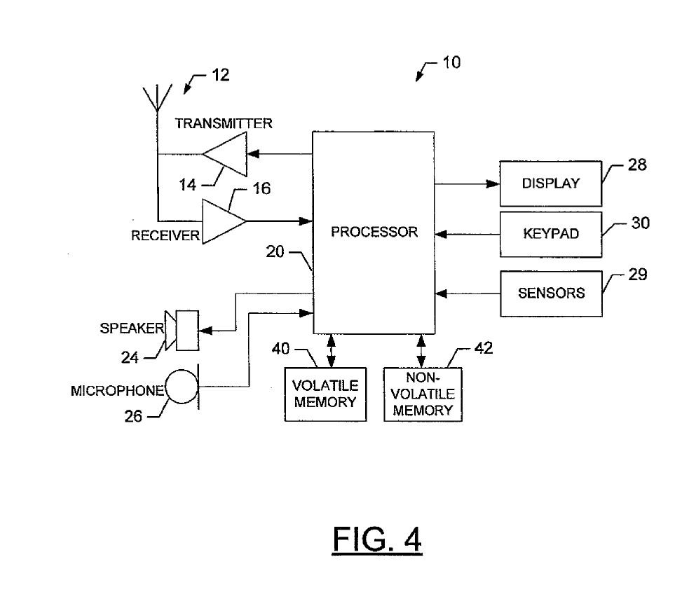

The description provided above and generally herein illustrates example methods, example apparatuses, and example computer program products for modeling personalized contexts. FIGS. 3 and 4 depict an example apparatuses that are configured to perform various functionalities as described herein, such as those described with respect to FIGS. 1a, 1b, 2, and 5.

Referring now to FIG. 3, an example embodiment of the present invention is the apparatus 200. Apparatus 200 may be embodied as, or included as a component of, an electronic device with wired or wireless communications capabilities. In some example embodiments, the apparatus 200 may be part of an electronic device, such as a stationary or a mobile terminal. As a stationary terminal, the apparatus 200 may be part of, or embodied as, a server, a computer, an access point (e.g., base station), communications switching device, or the like, and the apparatus 200 may access context data provided by a mobile device that captured the context data. As a mobile device, the apparatus 200 may be part of, or embodied as, a mobile and/or wireless terminal such as a handheld device including a telephone, portable digital assistant (PDA), mobile television, gaming device, camera, video recorder, audio/video player, radio, and/or a global positioning system (GPS) device), any combination of the aforementioned, or the like. Regardless of the type of device, apparatus 200 may also include computing capabilities.

The example apparatus 200 includes or is otherwise in communication with a processor 205, a memory device 210, an Input/Output (I/O) interface 206, a communications interface 215, a user interface 220, context data sensors 230, and a context modeler 232. The processor 205 may be embodied as various means for implementing the various functionalities of example embodiments of the present invention including, for example, a microprocessor, a coprocessor, a controller, a special-purpose integrated circuit such as, for example, an ASIC (application specific integrated circuit), an FPGA (field programmable gate array), or a hardware accelerator, processing circuitry or the like. According to one example embodiment, processor 205 may be representative of a plurality of processors, or one or more multiple core processors, operating in concert. Further, the processor 205 may be comprised of a plurality of transistors, logic gates, a clock (e.g., oscillator), other circuitry, and the like to facilitate performance of the functionality described herein. The processor 205 may, but need not, include one or more accompanying digital signal processors. In some example embodiments, the processor 205 is configured to execute instructions stored in the memory device 210 or instructions otherwise accessible to the processor 205. The processor 205 may be configured to operate such that the processor causes the apparatus 200 to perform various functionalities described herein.

Whether configured as hardware or via instructions stored on a computer-readable storage medium, or by a combination thereof, the processor 205 may be an entity capable of performing operations according to embodiments of the present invention while configured accordingly. Thus, in example embodiments where the processor 205 is embodied as, or is part of, an ASIC, FPGA, or the like, the processor 205 is specifically configured hardware for conducting the operations described herein. Alternatively, in example embodiments where the processor 205 is embodied as an executor of instructions stored on a computer-readable storage medium, the instructions specifically configure the processor 205 to perform the algorithms and operations described herein. In some example embodiments, the processor 205 is a processor of a specific device (e.g., mobile terminal) configured for employing example embodiments of the present invention by further configuration of the processor 205 via executed instructions for performing the algorithms, methods, and operations described herein.

The memory device 210 may be one or more computer-readable storage media that may include volatile and/or non-volatile memory. In some example embodiments, the memory device 210 includes Random Access Memory (RAM) including dynamic and/or static RAM, on-chip or off-chip cache memory, and/or the like. Further, memory device 210 may include non-volatile memory, which may be embedded and/or removable, and may include, for example, read-only memory, flash memory, magnetic storage devices (e.g., hard disks, floppy disk drives, magnetic tape, etc.), optical disc drives and/or media, non-volatile random access memory (NVRAM), and/or the like. Memory device 210 may include a cache area for temporary storage of data. In this regard, some or all of memory device 210 may be included within the processor 205.

Further, the memory device 210 may be configured to store information, data, applications, computer-readable program code instructions, and/or the like for enabling the processor 205 and the example apparatus 200 to carry out various functions in accordance with example embodiments of the present invention described herein. For example, the memory device 210 could be configured to buffer input data for processing by the processor 205. Additionally, or alternatively, the memory device 210 may be configured to store instructions for execution by the processor 205.

The I/O interface 206 may be any device, circuitry, or means embodied in hardware, software, or a combination of hardware and software that is configured to interface the processor 205 with other circuitry or devices, such as the communications interface 215. In some example embodiments, the processor 205 may interface with the memory 210 via the I/O interface 206. The I/O interface 206 may be configured to convert signals and data into a form that may be interpreted by the processor 205. The I/O interface 206 may also perform buffering of inputs and outputs to support the operation of the processor 205. According to some example embodiments, the processor 205 and the I/O interface 206 may be combined onto a single chip or integrated circuit configured to perform, or cause the apparatus 200 to perform, the various functionalities.

The communication interface 215 may be any device or means embodied in hardware, a computer program product, or a combination of hardware and a computer program product that is configured to receive and/or transmit data from/to a network 225 and/or any other device or module in communication with the example apparatus 200. The communications interface may be configured to communicate information via any type of wired or wireless connection, and via any type of communications protocol, such as communications protocol that support cellular communications. Processor 205 may also be configured to facilitate communications via the communications interface by, for example, controlling hardware included within the communications interface 215. In this regard, the communication interface 215 may include, for example, communications driver circuitry (e.g., circuitry that supports wired communications via, for example, fiber optic connections), one or more antennas, a transmitter, a receiver, a transceiver and/or supporting hardware, including, for example, a processor for enabling communications. Via the communication interface 215, the example apparatus 200 may communicate with various other network entities in a device-to-device fashion and/or via indirect communications via a base station, access point, server, gateway, router, or the like.

The user interface 220 may be in communication with the processor 205 to receive user input via the user interface 220 and/or to present output to a user as, for example, audible, visual, mechanical or other output indications. The user interface 220 may be in communication with the processor 205 via the I/O interface 206. The user interface 220 may include, for example, a keyboard, a mouse, a joystick, a display (e.g., a touch screen display), a microphone, a speaker, or other input/output mechanisms. Further, the processor 205 may comprise, or be in communication with, user interface circuitry configured to control at least some functions of one or more elements of the user interface. The processor 205 and/or user interface circuitry may be configured to control one or more functions of one or more elements of the user interface through computer program instructions (e.g., software and/or firmware) stored on a memory accessible to the processor 205 (e.g., volatile memory, non-volatile memory, and/or the like). In some example embodiments, the user interface circuitry is configured to facilitate user control of at least some functions of the apparatus 200 through the use of a display and configured to respond to user inputs. The processor 205 may also comprise, or be in communication with, display circuitry configured to display at least a portion of a user interface, the display and the display circuitry configured to facilitate user control of at least some functions of the apparatus 200.

The context data sensors 230 may be any type of sensors configured to capture context data about a user of the apparatus 200. For example, the sensor 230 may include a positioning sensor configured to identify the location of the apparatus 200 via, for example GPS positioning or cell-based positioning and the rate at which the apparatus 200 is currently moving. The sensors 230 may also include a clock/calendar configured to capture the current date/time, an ambient sound sensor configured to capture the level of ambient sound, a user activity sensor configured to monitor the user's activities with respect to the apparatus, and the like.

The context modeler 232 of example apparatus 200 may be any means or device embodied, partially or wholly, in hardware, a computer program product, or a combination of hardware and a computer program product, such as processor 205 implementing stored instructions to configure the example apparatus 200, memory device 210 storing executable program code instructions configured to carry out the functions described herein, or a hardware configured processor 205 that is configured to carry out the functions of the context modeler 232 as described herein. In an example embodiment, the processor 205 includes, or controls, the context modeler 232. The context modeler 232 may be, partially or wholly, embodied as processors similar to, but separate from processor 205. In this regard, the relevancy value generator 232 may be in communication with the processor 205. In various example embodiments, the context modeler 232 may, partially or wholly, reside on differing apparatuses such that some or all of the functionality of the context modeler 232 may be performed by a first apparatus, and the remainder of the functionality of the context modeler 232 may be performed by one or more other apparatuses.

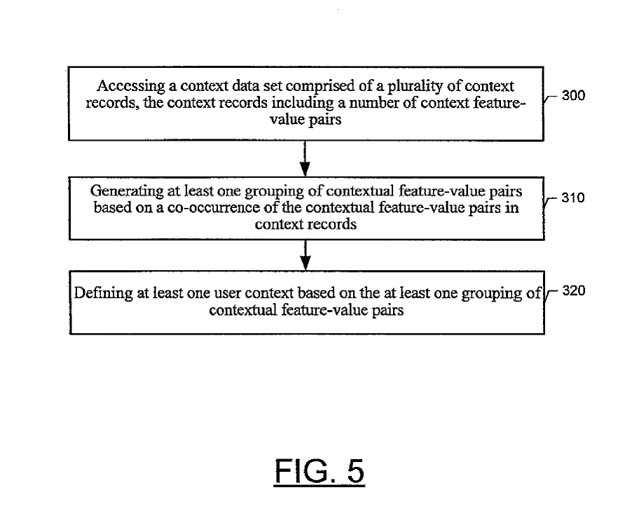

The apparatus 200 and the processor 205 may be configured to perform the following functionality via the context modeler 232. In this regard, the context modeler 232 may be configured to cause the processor 205 and/or the apparatus 200 to perform various functionalities, such as those depicted in the flowchart of FIG. 5 and as generally described herein. In this regard, the context modeler 232 may be configured to access a context data set comprised of a plurality of context records at 300. The context records may include a number of contextual feature-value pairs. The context modeler 232 may also be configured to generate at least one grouping of contextual feature-value pairs based on a co-occurrence of the contextual feature-value pairs in context records at 310. The context modeler 232 may also be configured to define at least one user context based on the at least one grouping of contextual feature-value pairs at 320.

In some example embodiments, being configured to access the context data set may include being configured to obtain the context data set based upon historical context data captured by a mobile electronic device, such as the apparatus 200. Further, in some example embodiments, being configured to generate the at least one grouping at 310 may include being configured to apply a topic model to the context data set, where the topic model includes a contextual feature template variable that describes the contextual features included in a given context record. Additionally, or alternatively, being configured to apply the topic model may include being configured to apply the topic model, where the topic model is a Latent Dirichlet Allocation model extended to include the contextual feature template variable. In some example embodiments, being configured to generate the at least one grouping of contextual feature-value pairs at 310 may include being configured to generate the at least one grouping of contextual feature-value pairs by clustering co-occurring contextual feature-value pairs.

Referring now to FIG. 4, a more specific example apparatus in accordance with various embodiments of the present invention is provided. The example apparatus of FIG. 4 is a mobile terminal 10 configured to communicate within a wireless network, such as a cellular communications network. The mobile terminal 10 may be configured to perform the functionality of the mobile terminal 101 and/or apparatus 200 as described herein. More specifically, the mobile terminal 10 may be caused to perform the functionality of the context modeler 232 via the processor 20. In this regard, processor 20 may be an integrated circuit or chip configured similar to the processor 205 together with, for example, the I/O interface 206. Further, volatile memory 40 and non-volatile memory 42 may be configured to support the operation of the processor 20 as computer readable storage media.

The mobile terminal 10 may also include an antenna 12, a transmitter 14, and a receiver 16, which may be included as parts of a communications interface of the mobile terminal 10. The speaker 24, the microphone 26, the display 28 (which may be a touch screen display), and the keypad 30 may be included as parts of a user interface. In some example embodiments, the mobile terminal 10 includes sensors 29, which may include context data sensors such as those described with respect to context data sensors 230. The mobile terminal 10 may also include an image and audio capturing module for capturing photographs and video content.

FIG. 5 illustrates flowcharts of example systems, methods, and/or computer program products according to example embodiments of the invention. It will be understood that each operation of the flowcharts, and/or combinations of operations in the flowcharts, can be implemented by various means. Means for implementing the operations of the flowcharts, combinations of the operations in the flowchart, or other functionality of example embodiments of the present invention described herein may include hardware, and/or a computer program product including a computer-readable storage medium (as opposed to a computer-readable transmission medium which describes a propagating signal) having one or more computer program code instructions, program instructions, or executable computer-readable program code instructions stored therein. In this regard, program code instructions may be stored on a memory device, such as memory device 210, of an example apparatus, such as example apparatus 200, and executed by a processor, such as the processor 205. As will be appreciated, any such program code instructions may be loaded onto a computer or other programmable apparatus (e.g., processor 205, memory device 210, or the like) from a computer-readable storage medium to produce a particular machine, such that the particular machine becomes a means for implementing the functions specified in the flowcharts' operations. These program code instructions may also be stored in a computer-readable storage medium that can direct a computer, a processor, or other programmable apparatus to function in a particular manner to thereby generate a particular machine or particular article of manufacture. The instructions stored in the computer-readable storage medium may produce an article of manufacture, where the article of manufacture becomes a means for implementing the functions specified in the flowcharts' operations. The program code instructions may be retrieved from a computer-readable storage medium and loaded into a computer, processor, or other programmable apparatus to configure the computer, processor, or other programmable apparatus to execute operations to be performed on or by the computer, processor, or other programmable apparatus. Retrieval, loading, and execution of the program code instructions may be performed sequentially such that one instruction is retrieved, loaded, and executed at a time. In some example embodiments, retrieval, loading and/or execution may be performed in parallel such that multiple instructions are retrieved, loaded, and/or executed together. Execution of the program code instructions may produce a computer-implemented process such that the instructions executed by the computer, processor, or other programmable apparatus provide operations for implementing the functions specified in the flowcharts' operations.

Accordingly, execution of instructions associated with the operations of the flowchart by a processor, or storage of instructions associated with the blocks or operations of the flowcharts in a computer-readable storage medium, support combinations of operations for performing the specified functions. It will also be understood that one or more operations of the flowcharts, and combinations of blocks or operations in the flowcharts, may be implemented by special purpose hardware-based computer systems and/or processors which perform the specified functions, or combinations of special purpose hardware and program code instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only and not for purposes of limitation.

1-27. (canceled)

28. A method comprising:
accessing a context data set comprised of a plurality of context records, the context records including a number of contextual feature-value pairs;
generating at least one grouping of contextual feature-value pairs based on a co-occurrence of the contextual feature-value pairs in context records; and
defining at least one user context based on the at least one grouping of contextual feature-value pairs.

29. The method according to claim 28, wherein accessing the context data set includes obtaining the context data set based upon historical context data captured by a mobile electronic device.

30. The method according to claim 28, wherein generating the at least one grouping includes applying a topic model to the context data set, the topic model including a contextual feature template variable that describes the contextual features included in a given context record.

31. The method according to claim 30, wherein applying the topic model includes applying the topic model, the topic model being a Latent Dirichlet Allocation model extended to include the contextual feature template variable.

32. The method according to claim 28, wherein generating the at least one grouping of contextual feature-value pairs includes generating the at least one grouping of contextual feature-value pairs by clustering the co-occurring contextual feature-value pairs.

33. An apparatus comprising at least one processor and at least one memory including computer program code, the at least one memory and the computer program code configured to, with the at least one processor, cause the apparatus at least to: access a context data set comprised of a plurality of context records, the context records including a number of contextual feature-value pairs;
generate at least one grouping of contextual feature-value pairs based on a co-occurrence of the contextual feature-value pairs in context records; and
define at least one user context based on the at least one grouping of contextual feature-value pairs.

34. The apparatus according to claim 33, wherein the apparatus caused to access the context data set includes being caused to obtain the context data set based upon historical context data captured by a mobile electronic device.

35. The apparatus according to claim 33, wherein the apparatus caused to generate the at least one grouping includes being caused to apply a topic model to the context data set, the topic model including a contextual feature template variable that describes the contextual features included in a given context record.

36. The apparatus according to claim 35, wherein the apparatus caused to apply the topic model includes being caused to apply the topic model, the topic model being a Latent Dirichlet Allocation model extended to include the contextual feature template variable.

37. The apparatus according to claim 33, wherein the apparatus caused to generate the at least one grouping of contextual feature-value pairs context records includes being caused to generate the at least one grouping of contextual feature-value pairs by clustering the co-occurring contextual feature-value pairs.

38. The apparatus according to claim 33, wherein the apparatus is a mobile terminal, and wherein the mobile terminal includes at least one sensor configured to capture context data.

39. The apparatus according to claim 38 further comprising an antenna connected to positioning circuitry, the positioning circuitry configured to receive signals via the antenna to determine location-based context data.

40. A computer readable medium having computer program code stored therein, the computer program code configured to cause an apparatus to perform:
accessing a context data set comprised of a plurality of context records, the context records including a number of contextual feature-value pairs;
generating at least one grouping of contextual feature-value pairs based on a co-occurrence of the contextual feature-value pairs in context records; and
defining at least one user context based on the at least one grouping of contextual feature-value pairs.

41. The computer readable medium according to claim 40, wherein the computer program code configured to cause the apparatus to perform accessing the context data set includes being configured to cause the apparatus to perform obtaining the context data set based upon historical context data captured by a mobile electronic device.

42. The computer readable medium according to claim 40, wherein the computer program code configured to cause the apparatus to perform generating the at least one grouping includes being configured to cause the apparatus to perform applying a topic model to the context data set, the topic model including a contextual feature template variable that describes the contextual features included in a given context record.

43. The computer readable medium according to claim 42, wherein the computer program code configured to cause the apparatus to perform applying the topic model includes being configured to cause the apparatus to perform applying the topic model, the topic model being a Latent Dirichlet Allocation model extended to include the contextual feature template variable.

44. The computer readable medium according to claim 40, wherein the computer program code configured to cause the apparatus to perform generating the at least one grouping of contextual feature-value pairs includes being configured to cause the apparatus to perform generating the at least one grouping of contextual feature-value pairs by clustering the co-occurring contextual feature-value pairs.

45. An apparatus comprising:
means for accessing a context data set comprised of a plurality of context records, the context records including a number of contextual feature-value pairs;
means for generating at least one grouping of contextual feature-value pairs based on a co-occurrence of the contextual feature-value pairs in context records; and
means for defining at least one user context based on the at least one grouping of contextual feature-value pairs.

46. The apparatus according to claim 45, wherein the means for accessing the context data set includes means for obtaining the context data set based upon historical context data captured by a mobile electronic device.

47. The apparatus according to claim 45, wherein the means for generating the at least one grouping includes means for applying a topic model to the context data set, the topic model including a contextual feature template variable that describes the contextual features included in a given context record.
